(19) United States
(12) Patent Application Publication
(10) Pub. No.: US 2022/0048118 A1
(43) Pub. Date: Feb. 17, 2022

(54) Axis Arrangement for a Machine Tool

(71) Applicant: WALTER MASCHINENBAU GMBH, Tübingen (DE)

(72) Inventor: Simon Kümmerle, Ammerbuch (DE)

(21) Appl. No.: 17/415,126

(22) PCT Filed: Dec. 6, 2019
(86) PCT No.: PCT/EP2019/083970

§ 371 Date: Jun. 17, 2021

(30) Foreign Application Priority Data
Dec. 18, 2018 (DE) 10 2018 132 614.9

(51) Int. Cl. B23B 31/20

(52) U.S. Cl. CPC B23B 31/207; B23B 2260/008; B23B 2270/027

(57) ABSTRACT

An axis arrangement for a machine tool is disclosed. In an axis housing a support spindle is rotationally supported about a longitudinal axis by a spindle bearing arrangement. The support spindle accommodates a clamping unit that can be switched between a clamping position and a release position by a cylinder device. The cylinder device has a piston that is moveable in an axial direction parallel to the longitudinal axis at which a piston rod is rotatably supported. In the cylinder housing the support spindle is supported in an axial direction at the cylinder housing via a first axial bearing. The piston rod is supported in the axial direction at the piston via a second axial bearing. Preferably the support spindle is exclusively supported in the axial direction in the cylinder housing.

The invention refers to an axis arrangement of a machine tool having an axis housing in which a clamping unit is rotatably supported. The clamping unit is configured to clamp a workpiece or a tool.

Such an axis arrangement can also be named as spindle. A spindle stock of a machine tool with a rotatably supported clamping unit that can be actuated by a hydraulic cylinder is, for example, known from DE 35 06 901 A1. Usually the clamping unit can be switched between a clamping position and a release position when actuated in axial direction.

It is an object of the present invention to provide an axis arrangement with a rotatably supported clamping unit that allows a wide range of use.

This object is solved by an axis arrangement with the features of claim 1.

The axis arrangement of the machine tool has an axis housing in which a support spindle for accommodation of a clamping unit is arranged. The clamping unit is configured to clamp a workpiece or a tool. The machine tool is preferably a grinding machine and/or an eroding machine. The support spindle is rotatably supported about a longitudinal axis in the axis housing by a spindle bearing arrangement. The clamping unit is connected with the support spindle in a torque-proof manner if it is arranged in the support spindle, such that they commonly form a rotatably supported unit.

For supporting the support spindle in the axis housing, preferably radially and/or axially supporting bearings are present. It is advantageous, if the spindle bearing arrangement at the axis housing comprises at least two angular contact bearings that are arranged in an O-arrangement. In the O-arrangement the lines of action of each angular contact bearing intersect the longitudinal axis at a location that is positioned on a side facing away from the respective other angular contact bearing.

A controllable cylinder device forms part of the axis arrangement. A cylinder device has a cylinder housing and a piston arranged in the cylinder housing. The piston is shiftably supported parallel to the longitudinal axis or along the longitudinal axis. The cylinder device or the piston is preferably pneumatically actuated.

The cylinder device has a first axial bearing that supports the clamping unit at the cylinder housing in axial direction. The support spindle is particularly supported only axially and not radially.

At the piston a piston rod is arranged for actuating the clamping unit. The piston rod is rotatably supported at the piston. In axial direction it is supported via a second axial bearing at the piston. The piston rod is preferably supported at the piston only axially and not radially.

Due to this arrangement, the rotating mass is very low, even in the case in which the piston rod is rotatably connected for actuating the clamping unit. If the clamping unit rotates about the longitudinal axis, the piston rod commonly rotates therewith. Because the piston rod can rotate relative to the piston, the piston can remain stationary inside the cylinder housing in rotation direction about the longitudinal axis. The cylinder housing itself neither rotates during a rotation of the clamping unit about the longitudinal axis.

In such an arrangement clamping units can be used that are biased in the clamping position by means of a spring packet as well as clamping units that have to be maintained in the clamping position by means of the cylinder device. In both cases a rotation with a sufficient rotating speed in the range of at least 1000 rotations per minute is possible in the clamping position.

It is also advantageous, if the support spindle is supported at the cylinder housing exclusively in axial direction, at least via the first axial bearing. The support spindle is not supported at the cylinder housing via radial bearings or angular contact bearings, such that no or only negligible small radial forces act on the clamping unit via the cylinder device. Preferably the cylinder device does not act on the clamping unit in radial direction, such that the radial guidance can be carried out exclusively via the spindle bearing arrangement in the axis housing. In doing so, the precision of the support is improved.

It is also preferred, if the piston bearing is exclusively supported in axial direction via at least one axial bearing at the piston. Particularly no radial bearings or angular contact bearings are present that support the piston rod radially at the piston or the cylinder housing. The piston rod can have contact to seals of the piston and/or the cylinder housing that allow the moveability of the piston rod in radial direction at least in a certain range. In doing so, it shall be avoided that radial forces are transmitted to the clamping unit via the piston rod.

In a preferred embodiment the cylinder housing is moveably supported in axial direction at the axis housing. The cylinder housing is arranged in a floating manner in axial direction so to speak. Thermal extensions of the clamping unit can be transferred over the first axial bearing onto the cylinder housing, wherein the cylinder housing is able to move relative to the axis housing. In doing so, it is avoided that axial clamping forces act on the spindle bearing arrangement.

Preferably the cylinder housing is arranged in a torque-proof manner about the longitudinal axis at the axis housing.

The cylinder device is particularly configured to switch the clamping unit between a clamping position and a release position. In one embodiment the piston rod can be without contact to the clamping unit in the clamping position. In this embodiment the piston rod is only in contact with the clamping unit, if the cylinder device switches the clamping unit or if the clamping unit is in the release position. For example the clamping unit can comprise a spring packet that biases the clamping unit in the clamping position without influence via the piston rod.

In another embodiment the piston rod and the clamping unit can be moveably coupled in axial direction as well as in rotation direction about the longitudinal axis. In this embodiment the cylinder device can be configured to retain the clamping unit in the release position as well as in the clamping position.

In an embodiment the cylinder device or the piston respectively are pneumatically actuated. The piston can fluidically separate two working chambers in the cylinder housing. Depending on which working chamber is put under a pneumatic pressure, the piston moves in axial direction toward the tool or workpiece to be clamped or away therefrom, whereby the switching between the release position and the clamping position and the retaining of the respective position can be effected.

Advantageous embodiments of the invention can be derived from the dependent claims, the description and the drawings. Subsequently, preferred embodiments of the invention are explained in detail with reference to the attached drawings. The drawings show:

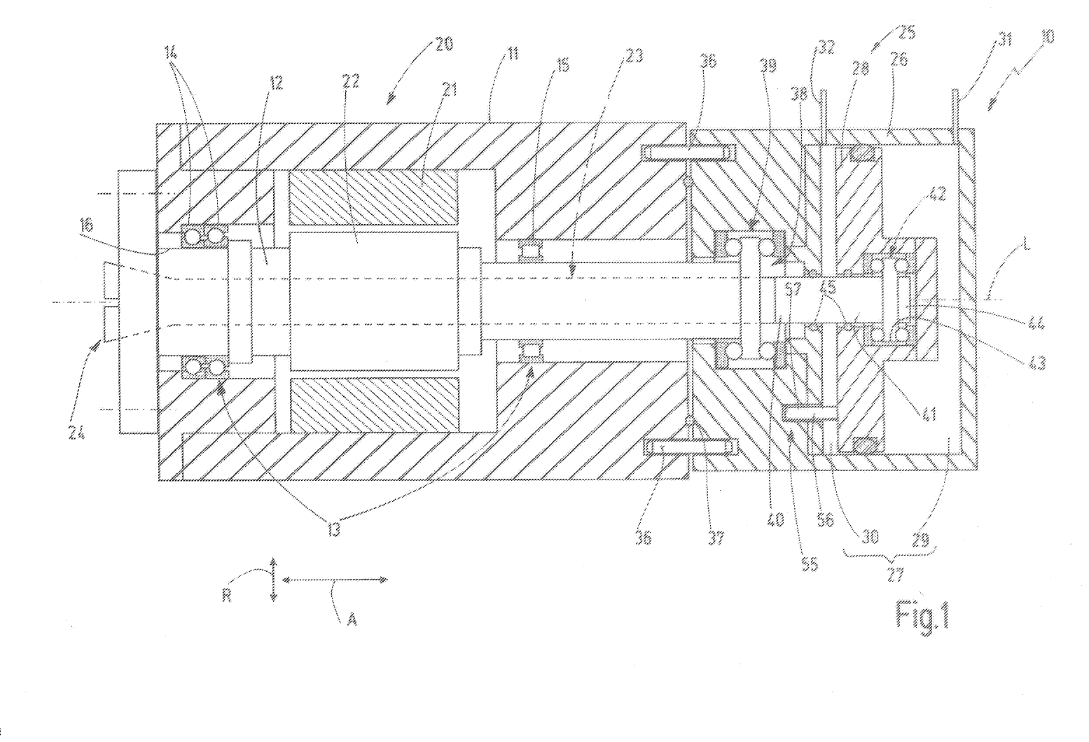

FIG. 1 a schematic block diagram sectional illustration of an embodiment of an axis arrangement,

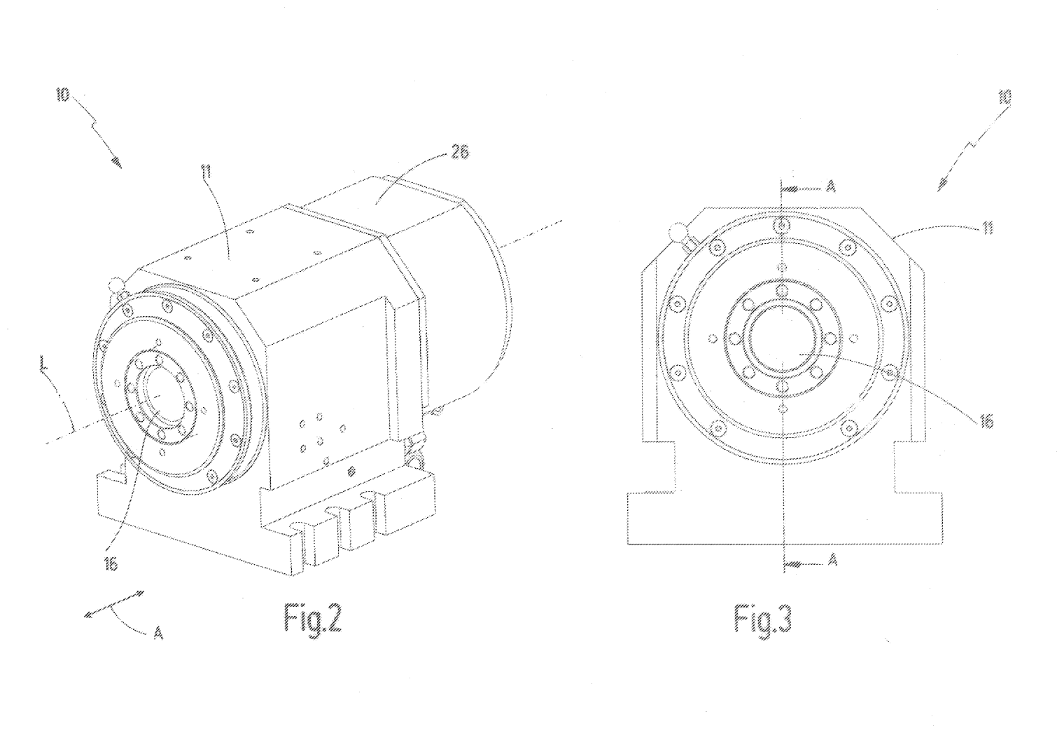

FIG. 2 a perspective view of an embodiment of an axis arrangement,

FIG. 3 the axis arrangement of FIG. 2 in a view in axial direction,

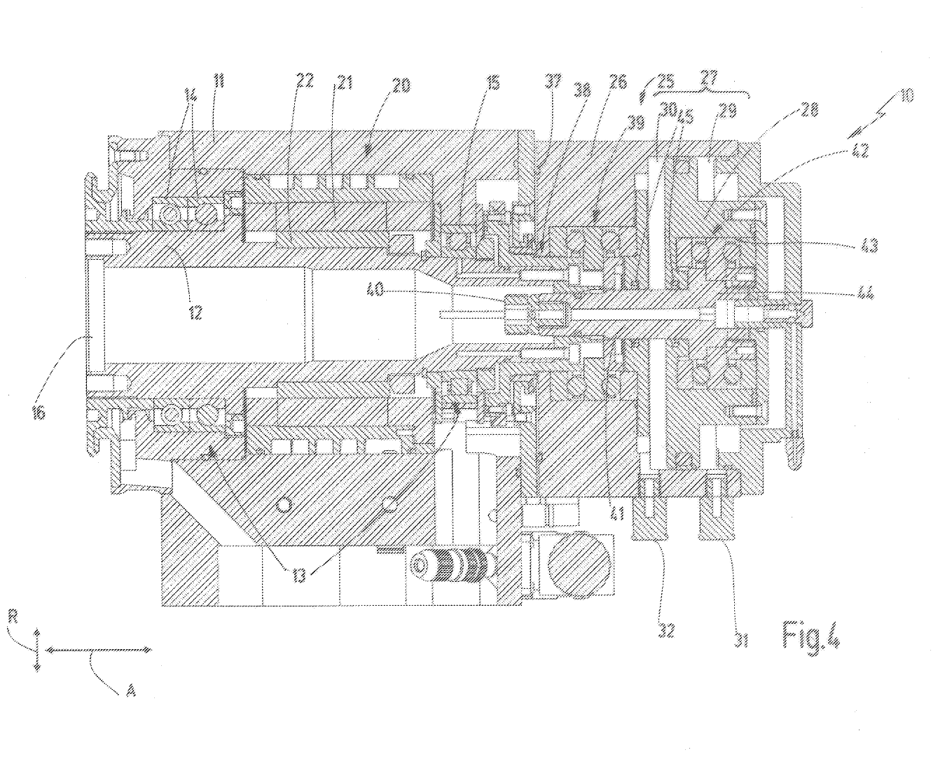

FIG. 4 a longitudinal section through the axis arrangement according to FIGS. 2 and 3 along the section plane A-A in FIG. 3, wherein no clamping unit is inserted in the axis housing of the axis arrangement,

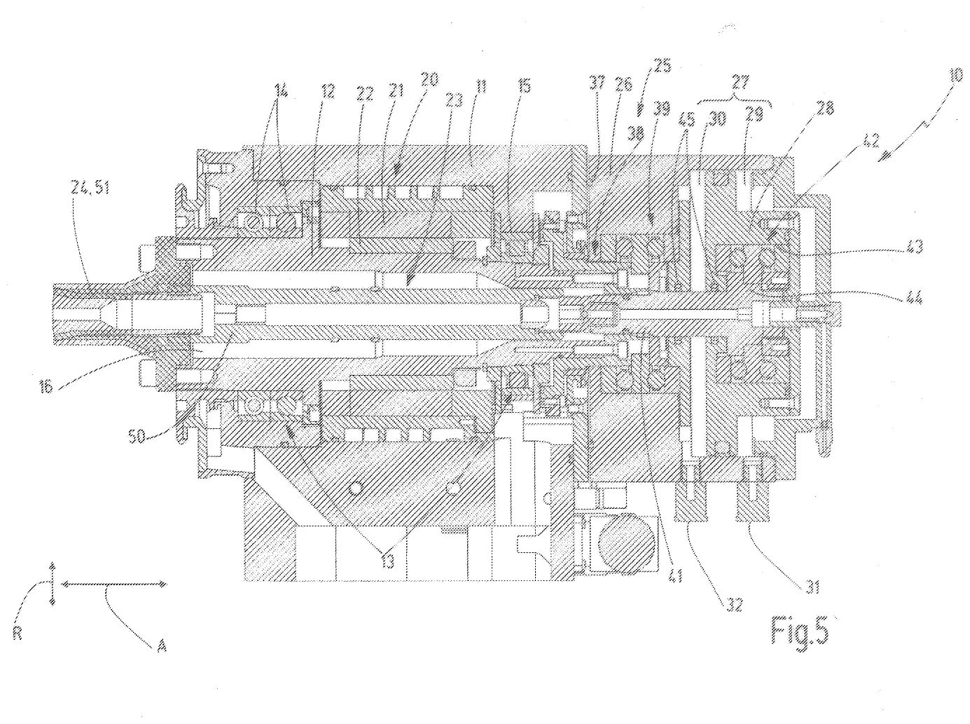

FIG. 5 the axis arrangement according to FIGS. 2-4 in the sectional view along the section plane A-A in FIG. 3, wherein a first embodiment of a clamping unit is present,

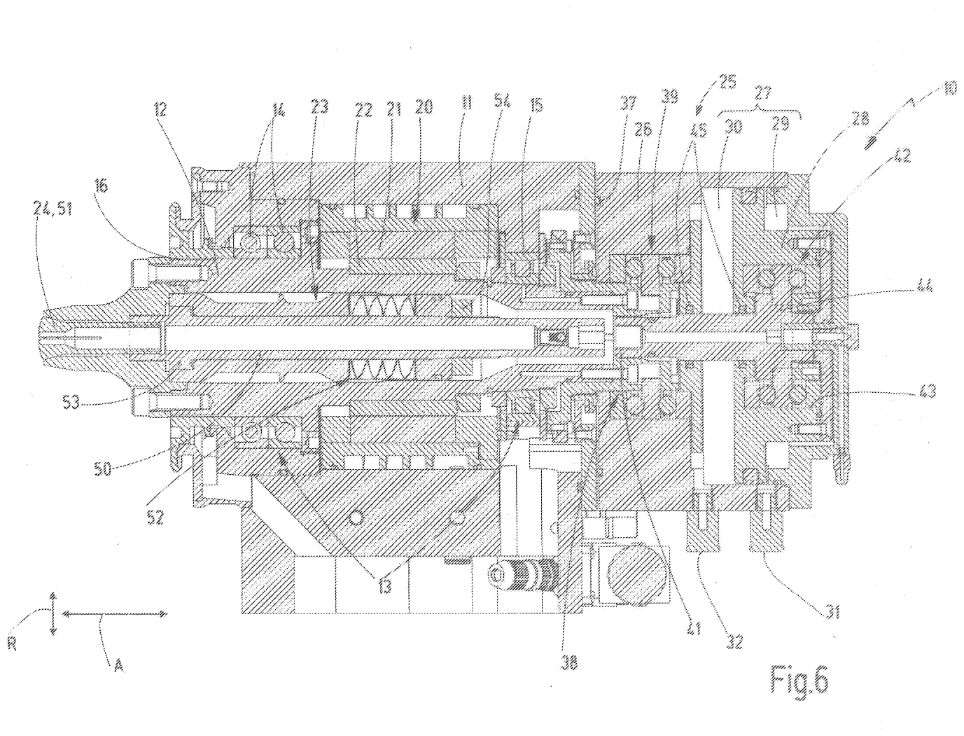

FIG. 6 the axis arrangement according to FIGS. 2-5 in the sectional view according to the section plane A-A in FIG. 3, wherein a second embodiment of a clamping unit is inserted,

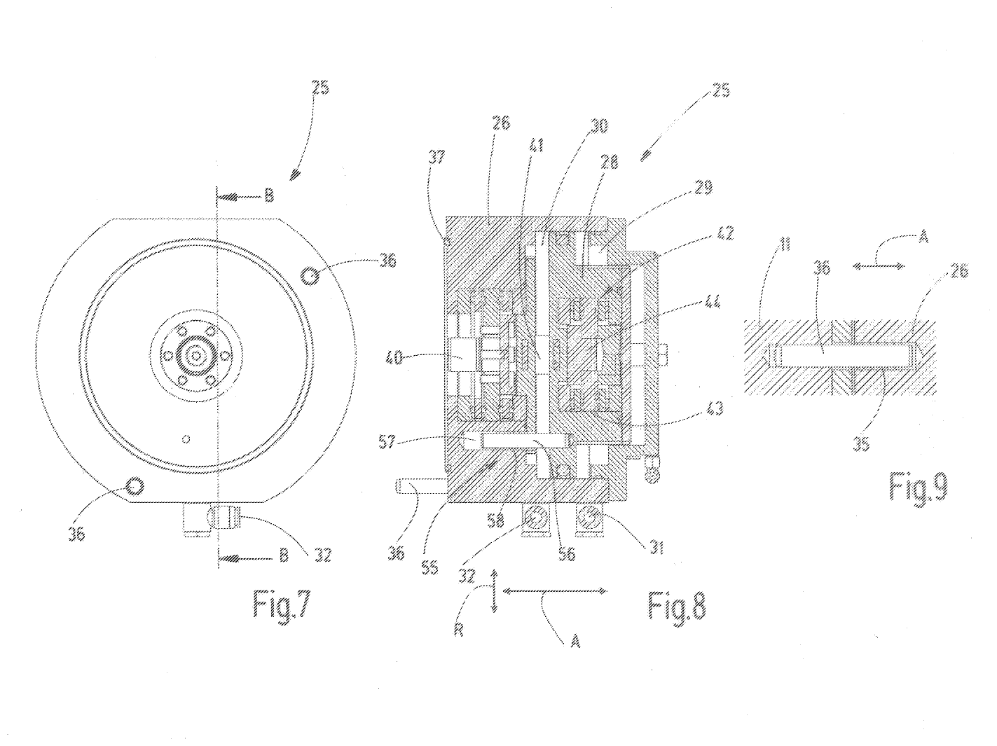

FIG. 7 a view of a cylinder device of the axis arrangement in axial direction,

FIG. 8 a sectional illustration of the cylinder device of FIG. 7 in the section plane B-B in FIG. 7,

FIG. 9 a schematic illustration of the support of a cylinder housing of the cylinder device at the axis housing of the axis arrangement.

FIG. 1 illustrates in the manner of a block diagram a highly simplified embodiment of an axis arrangement 10. The axis arrangement 10 has an axis housing 11, in which a support spindle 12 is rotatably supported about a longitudinal axis L. For rotational support a spindle bearing arrangement 13 is provided between the support spindle 12 and the axis housing 11, wherein the spindle bearing arrangement 13 supports the support spindle 12 in a radial direction R radially with reference to the longitudinal axis L at the axis housing 11. The spindle bearing arrangement comprises a plurality of radial bearings and/or angular contact bearings arranged in an axial direction A, parallel to the longitudinal axis L, with distance to each other, e.g. at least one angular contact bearing 14 and at least one radial bearing 15. In the illustrated embodiment two angular contact bearings 14 are present that can be configured as angular contact ball bearing respectively and are particularly arranged in an O-arrangement. The two angular contact bearings 14 can support radial as well as axial forces. The radial bearing 15 is, e.g. formed by a cylinder roller bearing. Thus, the spindle bearing arrangement 13 effects a support of the support spindle 12 in radial direction R and in axial direction A.

According to the example, the at least one angular contact bearing 14 is arranged nearby or adjacent to a face side opening 16 of the axis housing 11. The face side opening 16 faces the working area of the machine tool at least during the use of the axis arrangement 10 during machining of a workpiece.

In the axis housing 11 a motor 20 is arranged that is configured for driving the support spindle 12. The motor 20 has a stator 21 attached at the axis housing 11 and a rotor 22 attached at the support spindle 12.

The support spindle 12 is configured for accommodating a clamping unit 23. The clamping unit 23 is attached to the support spindle 12 in a torque-proof manner. The clamping unit 23 has a holding device in the region of the face side opening 16 for holding a workpiece or tool. Depending on the configuration of the tool or workpiece to be clamped, adaptors or exchangeable holding devices 24 can be used, such that the clamping unit 23 can be adapted to the respective tool or workpiece to be clamped.

The clamping unit 23 can be moved between a clamping position and a release position in axial direction A for clamping and releasing of a tool or workpiece. A cylinder device 25 of the axis arrangement 10 is present that is configured for switching from the clamping position in the release position and/or vice versa. The cylinder device 25 has a cylinder housing 26 that encloses a cylinder space 27. The cylinder space 27 is separated fluidically in a first working chamber 29 and a second working chamber 30 by a piston 28 that is moveable in axial direction A. A first fluid connection 31 leads into the first working chamber 29 and a second fluid connection 32 leads into the second working chamber 30.

The cylinder housing 26 is arranged at the axis housing 11 and locked against a relative rotation about the longitudinal axis L (compare FIGS. 1 and 9). The cylinder housing 26 is able to move in axial direction A relative to the axis housing 11, e.g. in order to be able to compensate temperature caused length changes of the support spindle 12. As it is schematically illustrated in FIGS. 1 and 9, a plurality of guide pins 36 is provided for this purpose, wherein the guide pins 36 extend in axial direction A and are either fixed at the axis housing 11 or the cylinder housing 26, whereas the respective other housing 11, 26 can be slideably moved relative to the guide pins 36 in axial direction A. According to the example, a plain bearing bush 35 is arranged in a cutout in the cylinder housing 26 in which the respective assigned guide pin 36 can slide in axial direction (FIG. 9).

Between the axis housing 11 and the cylinder housing 26 preferably a housing seal 37 is arranged in order to avoid the intrusion of contaminants in the area of the support spindle 12.

The support spindle 12 extends out of the axis housing 11 at the side opposite the face side opening 16 and into the cylinder housing 26. The back side end 38 of the support spindle 12 opposite the face side opening 16 is arranged in the cylinder housing 26. In doing so, it has to be noted that the support spindle 12 can be built from a plurality of parts connected with each other in a torque-proof manner. At the back side end 38 the support spindle 12 is supported via a first axial bearing 39 at the cylinder housing 26. Within the cylinder housing 26 the support spindle 12 is only supported in axial direction A, however, is not supported in radial direction R.

A free end 40 of a piston rod 41 is assigned to the back side end 38 of the support spindle 12. The piston rod 41 is rotationally supported about the longitudinal axis L at the piston 28. In doing so, the piston rod 41 is supported at the piston 28 via a second axial bearing 42 in axial direction A, however, not in radial direction R. In the embodiment the second axial bearing 42 is arranged in an inner space 43 of the piston 28. The inner end 44 of the piston rod 41 opposite the free end 40 is located in the inner space 43 and is supported at the piston via the second axial bearing 42.

If a movement of the piston 28 occurs in axial direction A, the piston rod 41 is moved together with the piston 28 in axial direction A or along the longitudinal axis L. Due to this movement, a switching of the clamping unit 23 between the release position and the clamping position can be executed. In doing so, it is possible to retain the clamping unit 23 by means of the cylinder device 25 in the clamping position as well as in the release position, e.g. if the piston rod 41 is moveably coupled with the clamping unit 23 in axial direction A in the moving direction toward the face side opening 16 as well as in the moving direction away from the face side opening 16. In another embodiment of the clamping unit 23 it can be biased in the clamping position by a spring packet. In this embodiment it is only necessary that a switching from a clamping position in the release position can be carried out by the cylinder device 25. For this purpose it can be sufficient to bring the free end of the piston rod 41 in contact with the clamping unit 23 for switching in the release position. If a movement occurs in the opposite direction away from the face side opening 16, the piston rod 41 does not effect a tension force on the clamping unit 23, but its movement out of the release position back into the clamping position is effected by the spring packet.

In the illustrated embodiment the cylinder device 25 is pneumatically operated. Via the fluid connections 31, 32 either the first working chamber 29 or the second working chamber 30 can be applied with a pneumatic pressure in order to move the piston and the piston rod.

If a thermal extension of the support spindle 12 occurs, the first axial bearing 39 is applied that in turn is supported at the cylinder housing 26. The cylinder housing 26 is floatingly supported and is able to move in axial direction A relative to the axis housing 11. In doing so, thermally caused introduction of stress in the spindle bearing arrangement 13 and particularly the angular contact bearings 14 is avoided.

Additionally, the axis arrangement 10 effects that embodiments of the clamping unit 23 with a spring packet as well as without spring packet can be used. If the clamping unit is biased in the clamping position by an own spring packet, the piston rod 41 can be decoupled from the clamping unit 23 in the clamping position and can be arranged with distance therefrom. If a rotation of the support spindle 12 about the longitudinal axis L occurs, the piston rod 41 does not rotate therewith.

If the cylinder device 25 is required in order to retain the clamping unit 23 in the release position as well as in the clamping position, the piston rod 41 can rotate about the longitudinal axis L together with the support spindle 12 relative to the piston 28 without the need to rotate the whole piston 28 or the whole cylinder device 25 therewith. The rotating masses and thus the moment of inertia are very small.

Via the cylinder device 25 no or only negligible small radial forces are transferred on the support spindle 12. In the cylinder housing 26 the back side end 38 of the support spindle 12 is not supported in radial direction R and only supported in axial direction A at the cylinder housing 26 by the first axial bearing 39. Also the piston rod 41 is moveable in radial direction R in a certain movement range, because the rotational support is effected only by the second axial bearing 42. In radial direction R the moveability of the piston rod 41 can be limited by one or more dynamic seals 45 that abut at a piston rod 41 in a sealing manner. In doing so, no substantial radial forces are induced on the piston rod 41.

For example a dynamic seal 45 can be arranged at the piston 28 in order to seal the second working chamber 30 from the inner space 43. Another dynamic seal 45 can be present between the cylinder housing 26 and the piston rod 41 in order to seal the second working chamber 30 toward the support spindle 12 or the clamping unit 23 respectively, wherein these dynamic seals 45 are preferably arranged between the first axial bearing 39 and the second working chamber 30 at the cylinder housing 26.

In FIGS. 2-6 another embodiment of the axis arrangement 10 is illustrated in different views. In these illustrations according to FIGS. 2-4, no clamping unit 23 is inserted into the support spindle 12. In the illustration according to FIG. 5 an embodiment of a clamping unit 23 that does not comprise a spring packet or other means for biasing the clamping unit 23 in the clamping position is inserted into the support spindle 12. In this embodiment the piston rod 41 is configured to effect a pressure force as well as to effect a tension force along the longitudinal axis L on a clamping rod 50 of the clamping unit 23. At the side opposite the piston rod 41 the clamping rod 50 is connected with a collet chuck 51, wherein the collet chuck 51 forms the holding device 24 for gripping a workpiece or tool in the embodiment. Thus the movement of the piston rod 41 in axial direction A can be transferred to the collet chuck 51 via the clamping rod 50. If the second working chamber 30 is put under fluid pressure and according to the example under pneumatic pressure and the first working chamber 29 is vented, the clamping unit 23 and according to the example the collet chuck is moved in the clamping position. If, on the contrary, the first working chamber 29 is put under pressure and the second working chamber 30 is vented, the clamping unit 23 is moved in the release position.

In the embodiment of the axis arrangement 10 illustrated in FIG. 6 a clamping unit 23 is inserted in which the clamping rod 50 is moveably coupled with the collet chuck 51 in axial direction A. Additionally, the clamping unit 23 comprises a spring packet 52 that is supported on one side at the axis housing 11 via a sleeve 53 coaxially surrounding the clamping rod 50 and is supported on the other side directly or indirectly via a ring 54 at the clamping rod 50. The spring packet 52 is biased and urges the clamping rod 50 in direction toward the piston rod 41. In doing so, the clamping unit 23 is biased in the clamping position. In the clamping position shown in FIG. 6 the piston rod 41 has an axial distance to the clamping rod 50. In case a rotation of the support spindle 12 about the longitudinal axis L occurs, the piston rod 41 remains stationary. In doing so, very high rotational speeds can be achieved.

For switching the clamping unit 23 from the clamping position in the release position, the first working chamber 29 is put under pressure, such that the piston 28 together with the piston rod 41 moves in direction toward the clamping rod 50. In doing so, the free end 40 of the piston rod 41 acts on the clamping rod 50 that is moved or shifted in axial direction A against the spring force of the spring packet 52 that in turn effects the switching of the clamping unit 23 from the clamping position in the release position. In this embodiment a mechanical contact between the piston rod 41 and the clamping unit 23 is only effective, if the clamping unit 23 is outside of the clamping position.

FIG. 8 illustrates a sectional view through the cylinder device 25 in the section plane B-B of FIG. 7. In this section—as well as in FIG. 1—a rotation lock 55 is apparent that locks the piston 28 against a rotational movement relative to the cylinder housing 26, if a rotation of the piston rod 41 about the longitudinal axis L occurs. The rotation lock 55 comprises a locking pin 56 that is connected with the piston 28 and that extends in axial direction A in a locking cutout 57 in the cylinder housing 26. The locking pin 56 can slide in the locking cutout 57 in axial direction A. For this a plain bearing bush 58 can be present in the locking cutout 57 for example. Thus the rotational lock can be configured in order to allow the floating support of the cylinder housing 26 at the axis housing 11 (compare FIGS. 1 and 9).

The invention refers to an axis arrangement 10 for a machine tool. In an axis housing 11 a support spindle 12 is rotationally supported about a longitudinal axis by means of a spindle bearing arrangement 13. The support spindle 12 serves to accommodate a clamping unit 23 that can be switched between a clamping position and a release position by means of a cylinder device 25. For this the cylinder device 25 has a piston 28 that is moveable in an axial direction A parallel to the longitudinal axis L at which a piston rod 41 is rotatably supported. In the cylinder housing 26 the support spindle 12 is supported in axial direction A at the cylinder housing 26 via a first axial bearing 39. The piston rod 41 is supported in axial direction A at the piston 28 via a second axial bearing 42. Preferably the support spindle 12 is exclusively supported in axial direction A in the cylinder housing 26.

### LIST OF REFERENCE SIGNS

10 axis arrangement
11 axis housing
12 support spindle
13 spindle bearing
14 angular contact bearing
15 radial bearing
16 face side opening
20 motor
1 stator
22 rotor
23 clamping unit
24 holding device
25 cylinder device
26 cylinder housing
27 cylinder space
28 piston
29 first working chamber
30 second working chamber
31 first fluid connection
32 second fluid connection
35 plain bearing bush
36 guide pin
37 housing seal
38 back side end of support spindle
39 first axial bearing
40 free end of the piston rod
41 piston rod
42 second axial bearing
43 inner space
44 inner end of the piston rod
45 dynamic seal
50 clamping rod
51 collet chuck
52 spring packet
53 sleeve
54 ring
55 rotation lock
56 locking pin
57 locking cutout
58 plain bearing bush
A axial direction
L longitudinal axis
R radial direction

1. An axis arrangement (10) for a machine tool, comprising:
a support spindle (12) arranged in an axis housing (11) and configured for accommodating a clamping unit (23), wherein the support spindle (12) is rotatably supported about a longitudinal axis (L) by a spindle bearing arrangement (13);
a controllable cylinder device (25) comprising:
a cylinder housing (26);
a piston (28) arranged in the cylinder housing, wherein the piston (28) is shiftably supported in an axial direction (A) parallel to the longitudinal axis (L) and at which a piston rod (41) is rotatably supported that is configured for actuating the clamping unit (23);
a first axial bearing (39) that supports the support spindle (12) in the axial direction (A) at the cylinder housing (26); and
a second axial bearing (42) that supports the piston rod (41) in the axial direction (A) at the piston (28).

2. The axis arrangement according to claim 1, wherein the spindle bearing arrangement (13) comprises two angular contact bearings (14) that are configured to support radial and axial forces.

3. The axis arrangement according to claim 1, wherein at least the first axial bearing (39) supports the support spindle (12) at the cylinder housing (26) exclusively in the axial direction (A).

4. The axis arrangement according to claim 1, wherein the second axial bearing (42) supports the piston rod (41) exclusively in the axial direction (A).

5. The axis arrangement according to claim 1, wherein the cylinder housing (26) is moveably supported at the axis housing (11) in the axial direction (A).

6. The axis arrangement according to claim 1, wherein the controllable cylinder device (25) is configured to shift the clamping unit (23) arranged in the support spindle (12) between a clamping position and a release position.

7. The axis arrangement according to claim 6, wherein the piston rod (41) does not contact the clamping unit (23) when the clamping unit (23) is in the clamping position.

8. The axis arrangement according to claim 6, wherein the piston rod (41) is moveably coupled with the clamping unit (23) in the axial direction (A).

9. The axis arrangement according to claim 1, wherein the piston (28) is locked against a relative rotation about the longitudinal axis (L) relative to the cylinder housing (26) by a rotation lock (55).

10. The axis arrangement according to claim 1, wherein the piston (28) is configured to be actuated pneumatically.
